(19) United States
(12) Patent Application Publication
(10) Pub. No.: US 2024/0167876 A1
(43) Pub. Date: May 23, 2024

(54) IMAGING HOUSING AND EXAMINATION DEVICE

(71) Applicant: FUJIFILM Corporation, Tokyo (JP)

(72) Inventors: Atsushi KAWANAGO, Saitama (JP); Yasunobu KISHINE, Saitama (JP)

(73) Assignee: FUJIFILM Corporation, Tokyo (JP)

(21) Appl. No.: 18/427,835

(22) Filed: Jan. 31, 2024

Related U.S. Application Data
(63) Continuation of application No. PCT/JP2022/023884, filed on Jun. 15, 2022.

(30) Foreign Application Priority Data
Aug. 23, 2021 (JP) 2021-135716

(51) Int. Cl. G01J 3/28; G01J 3/02

(52) U.S. Cl. CPC G01J 3/2823; G01J 3/0248; G01J 3/0291; G01J 2003/2826

(57) ABSTRACT

An imaging housing includes: a housing that covers an imaging space; an imaging device attachment part that is provided on a first surface of the housing and to which an imaging device is attached; and a light source attachment part that is provided on a second surface intersecting the first surface of the housing and to which a first light source that irradiates an inside of the housing is attached, where the housing is provided with a diffusion member therein, and has a first opening facing a lens of the imaging device on the first surface, a second opening on the second surface, and a movable plate that changes an opening region of the second opening into which light of the first light source is incident, and the light source attachment part has a changing mechanism capable of changing a direction of the first light source in the opening region.

### CROSS-REFERENCE TO RELATED APPLICATIONS

The present application is a Continuation of PCT International Application No. PCT/JP2022/023884 filed on Jun. 15, 2022 claiming priority under 35 U.S.C § 119(a) to Japanese Patent Application No. 2021-135716 filed on Aug. 23, 2021. Each of the above applications is hereby expressly incorporated by reference, in its entirety, into the present application.

### BACKGROUND OF THE INVENTION

### 1. Field of the Invention

The present invention relates to an imaging housing and an examination device.

### 2. Description of the Related Art

In the related art, a technology related to an examination device comprising an imaging device and an illumination device has been proposed.

For example, JP2018-4509A proposes a housing comprising an imaging device and an illumination device, and proposes a technology intended to stably evaluate a fabric product.

### SUMMARY OF THE INVENTION

An embodiment according to the technology of the present disclosure provides an imaging housing and an examination device that can perform irradiation by changing a diffusion degree of light from a light source according to a shape of a subject.

An imaging housing that is one aspect of the present invention for accomplishing the above object comprises: a housing that covers an imaging space; an imaging device attachment part that is provided on a first surface of the housing and to which an imaging device is attached; and a light source attachment part that is provided on a second surface intersecting the first surface of the housing and to which a first light source that irradiates an inside of the housing is attached, in which the housing is provided with a diffusion member therein, and has a first opening facing a lens of the imaging device on the first surface, a second opening on the second surface, and a movable plate that changes an opening region of the second opening into which light of the first light source is incident, and the light source attachment part has a changing mechanism capable of changing a direction of the first light source in the opening region.

It is preferable that the diffusion member is exchangeable.

It is preferable that the housing includes an insertion/removal mechanism, and the diffusion member is provided in the housing by the insertion/removal mechanism.

It is preferable that the diffusion member attached to a bottom part of the housing is removable.

It is preferable that an imaging device hood is provided on the first surface of the housing.

It is preferable that the imaging device is attachably and detachably attached to the imaging device attachment part.

It is preferable that the imaging device attachment part has an imaging direction adjustment mechanism that adjusts an imaging direction of the imaging device.

An examination device that is another aspect of the present invention comprises: the imaging housing described above; an imaging device that is provided in the imaging device attachment part; and a first light source that is provided in the light source attachment part.

It is preferable that the light source attachment part includes a first light source attachment part and a second light source attachment part, the first light source attachment part is provided with the first light source, and the second light source attachment part is provided with the second light source.

It is preferable that the examination device further comprises an intensity changing mechanism that changes wavelength intensities of the first light source and the second light source.

It is preferable that the first light source is a halogen lamp, and the second light source is a metal halide lamp.

It is preferable that the imaging device is a multispectral camera, and the multispectral camera is a pupil division type in which a plurality of band-pass filters are disposed at a pupil position or in the vicinity of the pupil position.

### BRIEF DESCRIPTION OF THE DRAWINGS

FIG. 1 is a conceptual diagram illustrating an examination device.

FIG. 2 is a perspective view of an imaging housing.

FIG. 3 is a diagram of the imaging housing as viewed from a Y-axis direction.

FIG. 4 is a plan view of the imaging housing.

FIG. 5 is a bottom view of the imaging housing.

FIG. 6 is a diagram conceptually illustrating an example of characteristics of a diffusion member.

FIG. 7 is a front view of an irradiation opening facing the front.

FIG. 8 is a front view of the irradiation opening facing the front.

FIG. 9A and FIG. 9B are diagrams illustrating a diffusion degree of light of a first light source according to a position of a movable plate.

FIG. 10 is a cross-sectional view of a lens device mounted on a multispectral camera in a direction of an optical axis L.

FIG. 11 is a conceptual diagram illustrating the examination device.

FIG. 12 is a perspective view of the imaging housing.

FIG. 13 is a diagram illustrating spectral data of a halogen lamp.

FIG. 14 is a diagram illustrating spectral data of a metal halide lamp.

### DESCRIPTION OF THE PREFERRED EMBODIMENTS

In the following, an imaging housing and an examination device according to preferred embodiments of the present invention will be described with reference to the accompanying drawings.

### First Embodiment

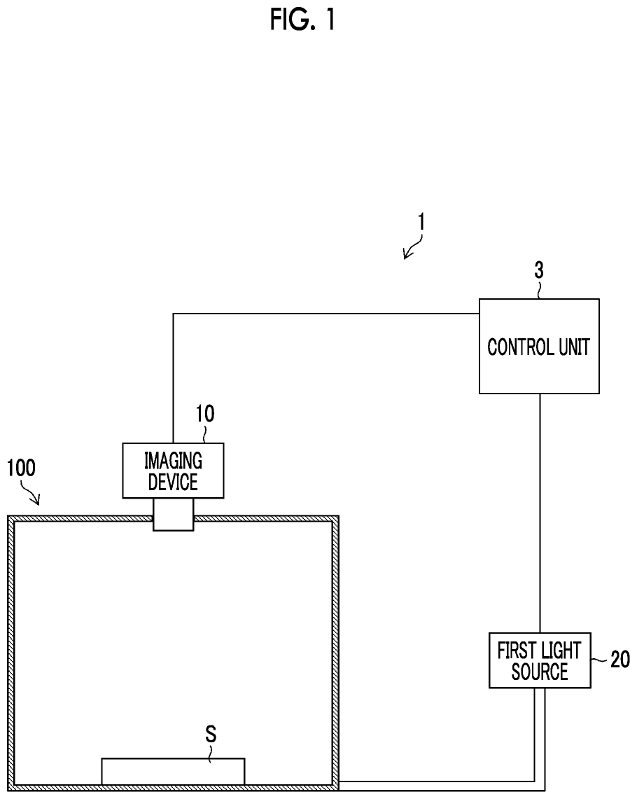

FIG. 1 is a conceptual diagram illustrating an examination device according to the present embodiment.

The examination device 1 comprises a control unit 3, an imaging device 10, a first light source 20, and an imaging housing 100.

The imaging housing 100 comprises the imaging device 10 and a first light source 20, and a workpiece S, which is an examination target, is disposed inside the imaging housing 100.

The imaging device 10 is attachably and detachably attached to the imaging housing 100, and images the workpiece S which is an examination object. As the imaging device 10, for example, a multispectral camera, a hyperspectral camera, and the like are used. The workpiece S can be examined by imaging the workpiece S with the imaging device 10 and by analyzing the obtained data. The imaging device 10 is attached to the imaging housing 100 and images the workpiece S in an imaging space covered with the imaging housing 100 (housing 111).

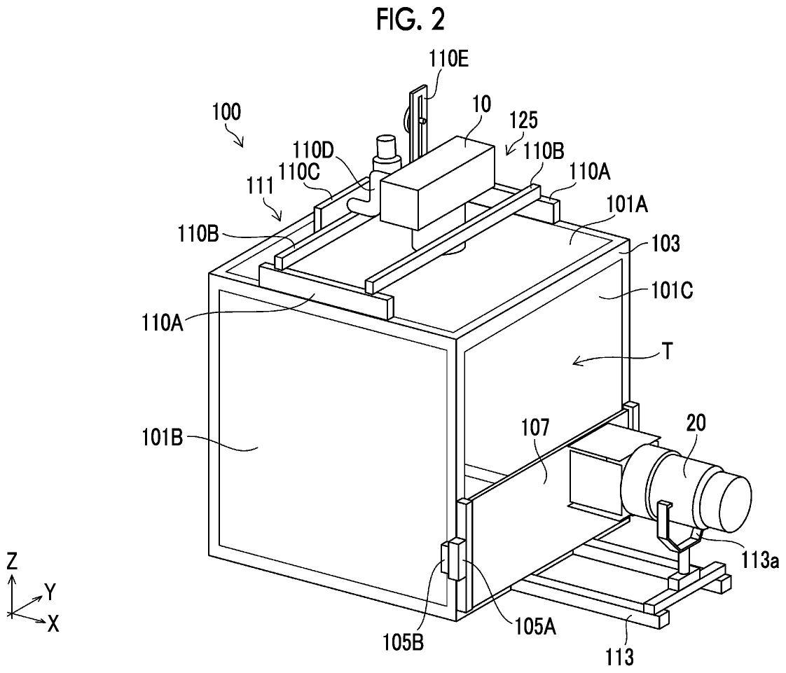

The first light source 20 is an illumination device that irradiates the workpiece S with light. As the first light source 20, a halogen lamp, a metal halide lamp, a light emitting diode (LED) lamp, and the like are used. The first light source 20 is attached to the imaging housing 100 by a first light source attachment part (light source attachment part) 113 (FIG. 2).

The control unit 3 is composed of a computer, and controls operations of the imaging device 10 and the first light source 20 by executing a program stored in a memory by a central processing unit (CPU: processor) mounted on the computer. For example, the control unit 3 controls the start and the end of imaging of the imaging device 10. In addition, for example, the control unit 3 acquires and analyzes data of a still image or a motion picture of the workpiece S, which is acquired by the imaging device 10, and outputs an examination result. In addition, for example, the control unit 3 controls power ON/OFF of the first light source 20. In addition, the control unit 3 can integrally control the operation related to the examination device 1.

<<Imaging Housing>>

Next, the imaging housing 100 provided in the examination device 1 will be described.

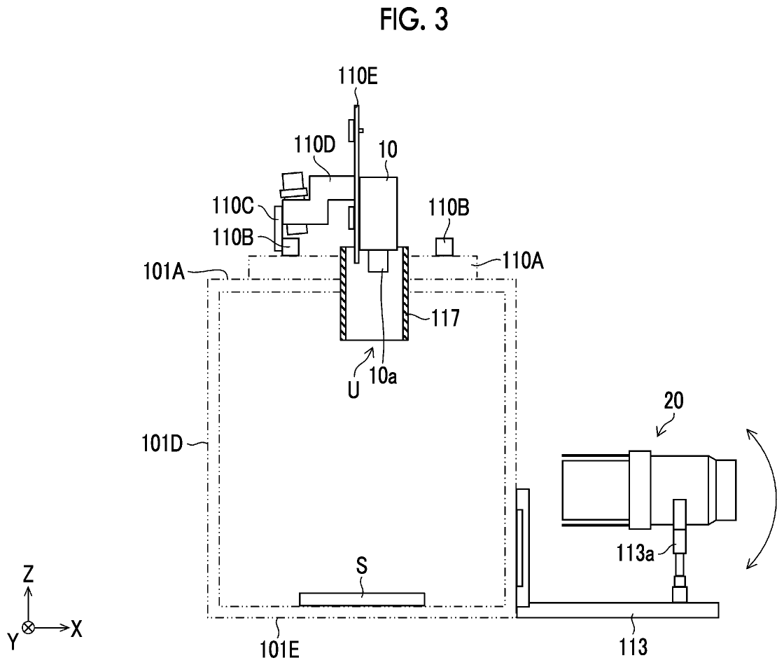

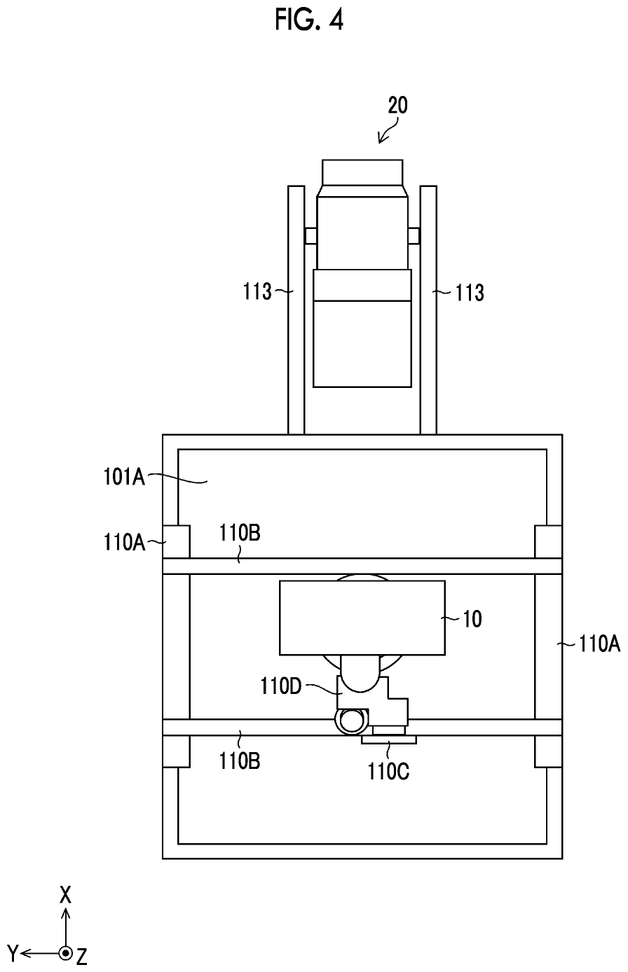

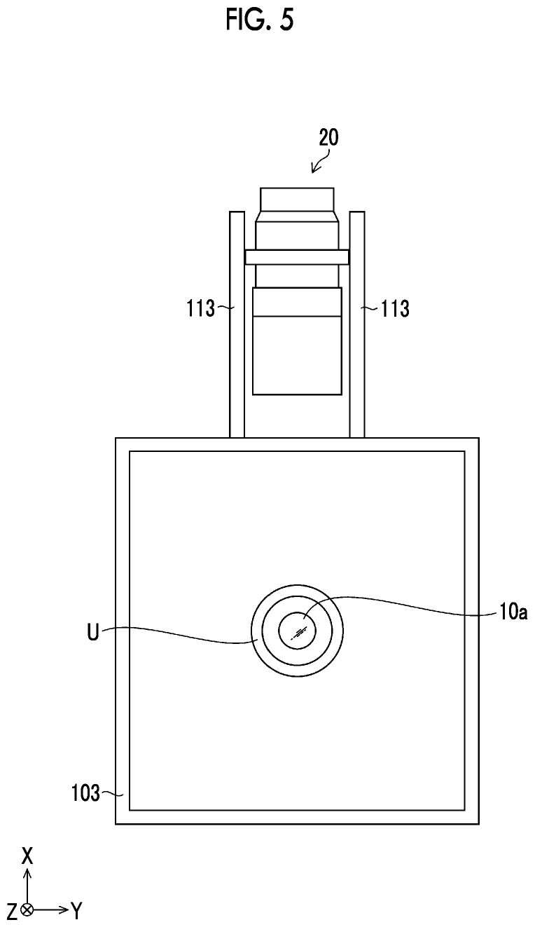

FIGS. 2 to 5 are diagrams illustrating the imaging housing 100. FIG. 2 is a perspective view of the imaging housing 100, FIG. 3 is a diagram of the imaging housing 100 as viewed in a Y-axis direction, FIG. 4 is a plan view of the imaging housing 100, and FIG. 5 is a bottom view of the imaging housing 100. In FIG. 3, some members are illustrated by imaginary lines (two-dot chain lines). In addition, in FIG. 5, a panel 101E is omitted.

As illustrated in FIG. 2, the imaging housing 100 comprises a housing 111, an imaging device attachment part 125, and the first light source attachment part (light source attachment part) 113.

<<Housing>>

It is preferable that the housing 111 has a box shape such as a cubic shape or a rectangular parallelepiped shape. The housing 111 is composed of a panel frame 103 and panels (101A, 101B, 101C, 101D, and 101E) attached to the panel frame 103. Specifically, the panel 101A is provided on an upper surface of the housing 111, the panel 101E is provided on a bottom surface of the housing 111, and the panel 101B, the panel 101C, and the panel 101D are provided on three side surfaces among four side surfaces of the housing 111 (refer to FIGS. 2 and 3). An irradiation opening T (second opening) for performing irradiation of light by the first light source 20 is formed on one side surface (second surface) of the housing 111 on which no panel is provided (refer to FIG. 2). An opening region of the irradiation opening T is changed by a movable plate 107 as will be described later. The movable plate 107 is attached by movable plate attachment parts 105A and 105B provided on the panel frame 103 and the movable plate 107, respectively (refer to FIG. 2). The movable plate 107 can be moved in an up-down direction (a positive direction and a negative direction of a Z axis). Then, a diffusion degree of the light of the first light source 20 can be changed by the movement of the movable plate 107. FIGS. 2 and 3 illustrate a state in which the movable plate 107 is positioned on a lower side. On the other hand, in a case where the movable plate 107 is positioned on an upper side, the movable plate attachment parts 105A and 105B are attached to the upper side (the positive side in the Z-axis direction).

A lens opening U (first opening) is provided on an upper surface (a surface formed by the panel 101A: first surface) of the housing 111 (refer to FIGS. 3 and 5). The lens opening U is disposed so as to face a lens barrel (lens) 10a of the imaging device 10 (refer to FIG. 5). Then, the imaging device 10 is installed facing downward (in the negative direction of the Z axis), and images the workpiece S disposed on the bottom surface (surface formed by the panel 101E) of the housing 111. In addition, an imaging device hood 117 is provided in the lens opening U provided in the panel 101A (refer to FIG. 3). The imaging device hood 117 functions as a light shield for the imaging device 10 and assists appropriate imaging of the imaging device 10. The upper surface (first surface) and the side surface (second surface) of the housing 111 intersect each other.

<<Diffusion Member>>

A diffusion member is provided inside the housing 111. Specifically, the panels 101A to 101E are composed of diffusion plates. In addition, a diffusion member is also provided on an inner surface (surface opposite to the surface facing the first light source 20) of the movable plate 107. Specifically, it is composed of the same diffusion plate as the panels 101A to 101E.

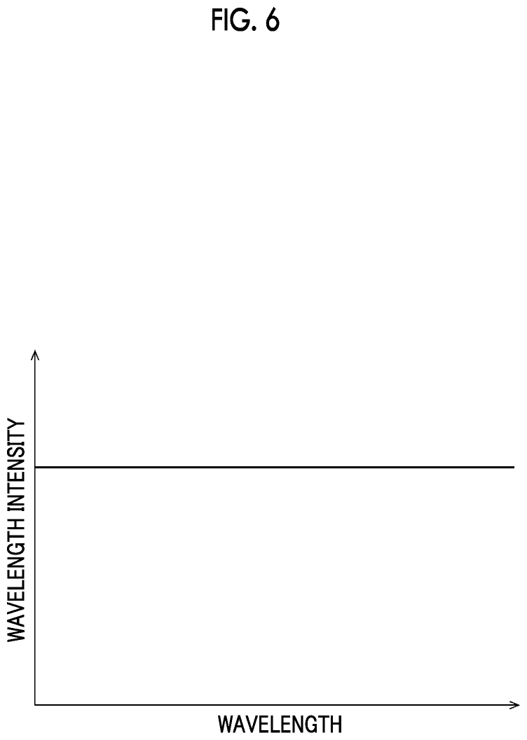

FIG. 6 is a diagram conceptually illustrating an example of characteristics of the diffusion member used in the housing 111. A vertical axis indicates the wavelength intensity, and a lateral axis indicates the wavelength.

In a case of considering that a multispectral camera or a hyperspectral camera is used as the imaging device 10, it is preferable to use diffusion members having the same wavelength intensities at least between wavelengths used in the imaging device 10. For example, as illustrated in FIG. 6, it is preferable to use diffusion members having a characteristic in which the wavelength intensity is flat in a predetermined wavelength range. It is possible to suppress an error in data obtained at each wavelength by using such a diffusion member for the housing 111. The diffusion member is exchangeably provided in the imaging housing 100. Specifically, the panels 101A to 101E are provided on a panel frame 103 by an insertion/removal mechanism (not illustrated), and the panels 101A to 101E are exchangeable. In addition, the panel 101E provided at a bottom part of the imaging housing 100 is removable. It is possible to examine the workpiece S continuously conveyed by a conveyor belt by removing the panel 101E and by installing the imaging housing 100 on an upper part of the conveyor belt.

<<Light Source Attachment Part>>

The first light source 20 is attached to the imaging housing 100 by a first light source attachment part 113. The first light source attachment part 113 has a changing mechanism 113a that can change the direction of the first light source 20 (refer to FIGS. 2 and 3). The direction of the first light source 20 is changed by the changing mechanism 113a to irradiate the irradiation opening T with light. The direction of the first light source 20 is changed manually or automatically.

<<Imaging Device Attachment Part>>

The imaging device 10 is attachably and detachably attached to the housing 111 by an imaging device attachment part 125 provided on the panel 101A. The imaging device attachment part 125 is composed of a first attachment member 110A, a second attachment member 110B, an attachment plate 110C, a tripod head 110D, and a height adjustment mechanism 110E (refer to FIGS. 2 and 4). Two first attachment members 110A are provided in parallel on the panel 101A and the panel frame 103 in pairs. Two second attachment members 110B are provided on the first attachment member 110A in pairs in parallel so as to be orthogonal to the first attachment member 110A. A lower end of the attachment plate 110C is attached to the second attachment member 110B, and an upper end of the attachment plate 110C is attached to the tripod head 110D (imaging direction adjustment mechanism). The tripod head 110D is attached to the body of the imaging device 10, and can adjust the imaging direction of the imaging device 10. In addition, the height adjustment mechanism 110E is attached to the body of the imaging device 10. The height adjustment mechanism 110E can adjust a height (displacement in the Z-axis direction) of the imaging device 10.

<<Movement of Movable Plate>>

Next, the irradiation opening T that is changed by the movement of the movable plate 107 will be described. As the movable plate 107 moves, the opening region of the irradiation opening T into which the light of the first light source 20 is incident changes. Accordingly, it is possible to change the diffusion degree of the light of the first light source 20 that is emitted onto the workpiece S.

In the examination using the imaging device 10, a shadow is generated in the imaging range and the shadow is imaged as it is, this may cause erroneous detection in the examination. Therefore, the light from the first light source 20 is diffused and emitted onto the workpiece S to suppress the generation of the shadow, and thus it is possible to perform examination with high accuracy. On the other hand, in a case where a multispectral camera (or a multispectral polarization camera) is used in the imaging device 10, since input and polarization of only a specific wavelength are handled, attenuation of the amount of light is greater than that of a general camera. Therefore, in a case where a multispectral camera (or a multispectral polarization camera) is used in the imaging device 10, there is a case where it is possible to perform examination with higher accuracy by irradiating the workpiece S with the light of the first light source 20 as direct light rather than irradiating the workpiece S with the light as diffused light.

Therefore, in the technology of the present disclosure, the opening region of the irradiation opening T is changed by moving the movable plate 107, and the diffusion degree is changed according to the shape of the workpiece S or the necessary amount of the light of the multispectral camera used in the imaging device 10. Accordingly, an examination with high accuracy can be realized in the examination device 1.

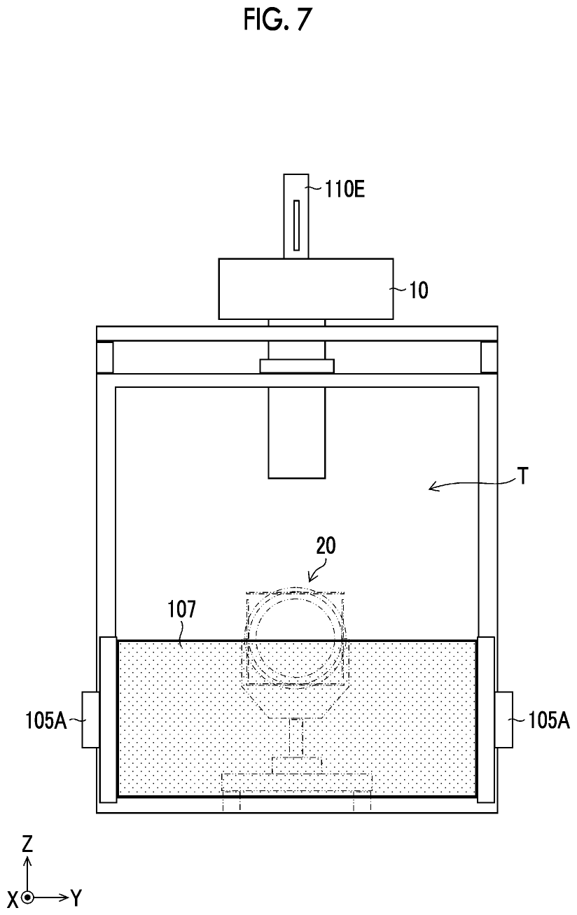

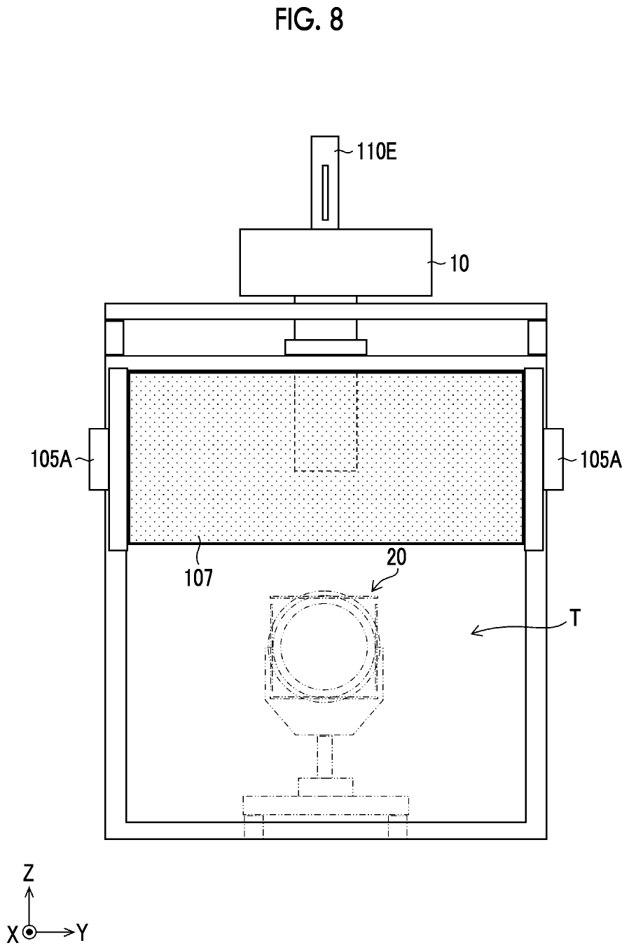

FIGS. 7 and 8 are front views of the irradiation opening T facing the front. FIG. 7 illustrates a case where the movable plate 107 is positioned on the lower side, and FIG. 8 illustrates a case where the movable plate 107 is positioned on the upper side.

Since the movable plate 107 is positioned on the lower side, the irradiation opening T is positioned on the upper side (refer to FIG. 7). On the other hand, in a case where the movable plate 107 is positioned on the upper side, the irradiation opening T is positioned on the lower side (refer to FIG. 8). The movable plate 107 is moved manually or automatically. In the case illustrated in FIG. 2, the movable plate 107 is moved manually, and the movable plate 107 is attached to the lower side by movable plate attachment parts 105A and 105B that are composed of magnets.

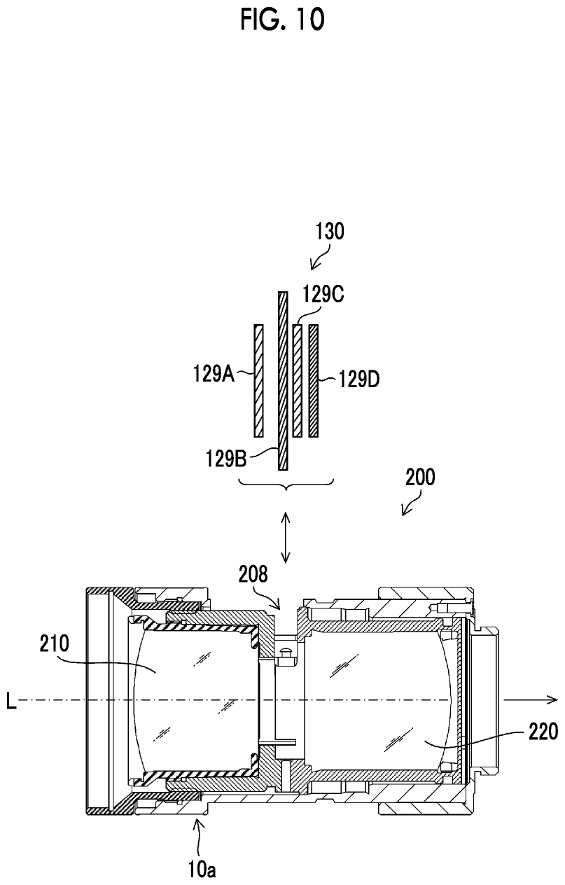

The position of the movable plate 107 is determined according to the height of the workpiece S with respect to the movable plate 107. Specifically, in a case where the height of the workpiece S is equal to or greater than a threshold value, the movable plate 107 is moved to the lower side, and in a case where the height of the workpiece S is less than the threshold value, the movable plate 107 is moved to the upper side. The height of the workpiece S can be measured by various methods. For example, the height of the workpiece S may be measured manually using a scale or the like. In addition, the height of the workpiece S may be measured using light detection and ranging (LiDAR). In addition, in a case where the imaging device 10 is a compound eye type, the height of the workpiece S may be measured using the imaging device 10. In addition, in a case where the imaging device 10 is a multispectral polarization camera (FIG. 10) which will be described later, the height of the workpiece S may be estimated by using the misregistration due to pupil division or from left and right perspective shapes.

Next, the diffusion degree of the luminous flux of the first light source 20 according to the position of the movable plate 107 will be described.

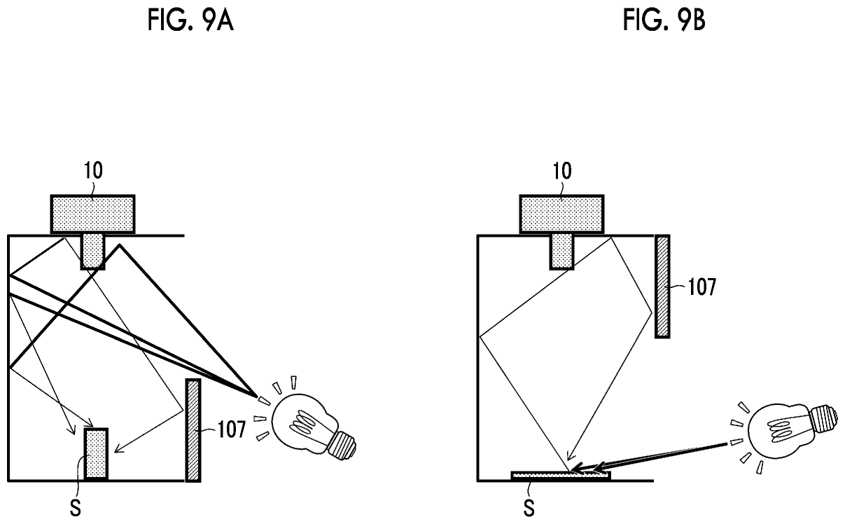

FIG. 9A and FIG. 9B are diagrams illustrating the diffusion degree of the light of the first light source 20 according to the position of the movable plate 107.

In FIG. 9A, the height of the workpiece S is equal to or greater than the threshold value, and the shadow of the workpiece S is likely to be generated. In such a case, the generation of the shadow is suppressed by increasing the diffusion degree of the light of the first light source 20 and by irradiating the workpiece S with the light. Specifically, it is possible to irradiate the workpiece S with the light having high diffusion degree by moving the movable plate 107 to the lower side to form the irradiation opening T in the upper part and by emitting the light with the first light source 20 toward the irradiation opening T.

In FIG. 9B, the height of the workpiece S is less than the threshold value, and the shadow of the workpiece S is unlikely to be generated. On the other hand, it is preferable that a multispectral camera is used as the imaging device 10 and the workpiece S is illuminated with the sufficient amount of light. In such a case, the workpiece S is directly irradiated with the light of the first light source 20. Specifically, it is possible to directly irradiate the workpiece S with the light by moving the movable plate 107 to the upper side to form the irradiation opening T in the lower part and by emitting the light with the first light source 20 toward the irradiation opening T.

As described above, according to the imaging housing 100 included in the examination device 1, it is possible to change the diffusion degree of the light of the first light source 20 and to irradiate the workpiece S with the light by moving the movable plate 107. Specifically, it is possible to perform the examination by suppressing the generation of the shadow of the workpiece S by increasing the diffusion degree of the light, or it is possible to perform the examination by directly irradiating the workpiece S with the light by decreasing the diffusion degree of the light. Accordingly, the examination device 1 can appropriately perform imaging of the workpiece S by the imaging device 10, and can perform the examination with high accuracy.

### Second Embodiment

Next, a second embodiment will be described. The examination device 1 according to the present embodiment comprises the first light source 20 and a second light source 21.

First, a multispectral camera used as an example of the imaging device 10 will be described.

The brightness information of the multispectral camera is determined by “ambient light”, “band-pass filter (BPF) spectral characteristics”, and “sensor sensitivity”. In a case where the multispectral camera is manufactured, the BPF and a neutral density (ND) filter are laminated and adjusted so that a brightness level of each selected wavelength becomes homogeneous.

FIG. 10 is a cross-sectional view of a lens device mounted on the multispectral camera in a direction of an optical axis L. The multispectral camera used as an example of the imaging device 10 is a pupil division type in which a plurality of band-pass filters are disposed at a pupil position or in the vicinity of the pupil position as described below.

In the lens device 200, a single imaging optical system that is composed of a first lens 210 and a second lens 220 is disposed on the lens barrel 10a. Zoom and/or focus is adjusted by moving the first lens 210 and the second lens 220 in a direction of the optical axis L. The first lens 210 and the second lens 220 may be a lens group that is composed of a plurality of lenses. In addition, in the lens barrel 10a, a slit 208 is formed at the pupil position (in the vicinity of the pupil) of the lens device 200, and an optical member 130 is inserted into the slit 208.

The optical member 130 comprises an ND filter 129A, a frame 129B, a band-pass filter 129C, and a polarization filter 129D. The optical member 130 can be inserted into and removed from the lens barrel 10a. Four windows (opening regions) are provided on the frame 129B. Corresponding to the four windows, the band-pass filter 129C and the polarization filter 129D transmit different kinds of light. The light that has passed through the lens device 200 is received by a dedicated imaging element (sensor), so that the four imaging data (images) having different wavelengths can be acquired at the same time.

The optical member 130 having different characteristics can be used according to the characteristics of the light source (or the subject). In addition, the amount of light corresponding to the four windows can be adjusted by changing the filters (the ND filter 129A, the band-pass filter 129C, and the polarization filter 129D) of the optical member 130. However, it is complicated to laminate or select the filters and adjust the amount of the light for each of the four windows as described above. In addition, even in a case where the adjustment is performed once, in a case where the ambient light changes, the adjustment is required again, which is problematic from the viewpoint of general-purpose properties.

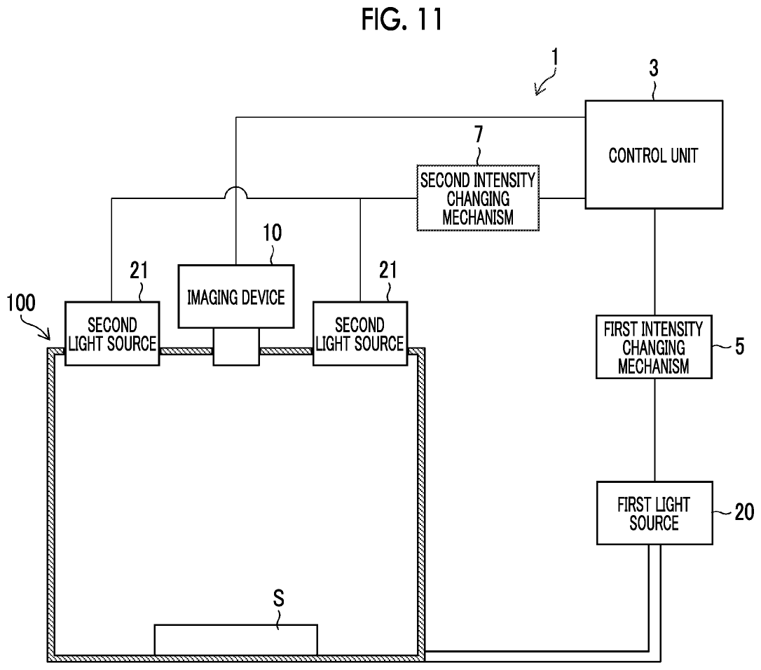

In the present embodiment, the amount of the light for each wavelength is adjusted by changing the spectral weights of the first light source 20 and the second light source 21 (FIG. 11) according to the selection of the wavelength in the multispectral camera.

FIG. 11 is a conceptual diagram illustrating the examination device 1 according to the present embodiment. The parts already described in FIG. 1 are denoted by the same reference numerals, and the description thereof will be omitted.

The examination device 1 comprises the control unit 3, the imaging device 10, the first light source 20, the second light source 21, the imaging housing 100, a first intensity changing mechanism 5, and a second intensity changing mechanism 7.

Similar to the first light source 20, the second light source 21 is an illumination device that irradiates the workpiece S with light. It is preferable that different types of light sources are used as the first light source 20 and the second light source 21. For example, a halogen lamp is used as the first light source 20, and a metal halide lamp is used as the second light source 21.

The control unit 3 controls power ON/OFF of the first light source 20 and the second light source 21. In addition, the control unit 3 changes the amount of the light of the first light source 20 through the first intensity changing mechanism 5. In addition, the control unit 3 changes the amount of the light of the second light source 21 through the second intensity changing mechanism 7. The first intensity changing mechanism 5 and the second intensity changing mechanism 7 can change the respective amount of the light of the first light source 20 and the second light source 21 by known techniques.

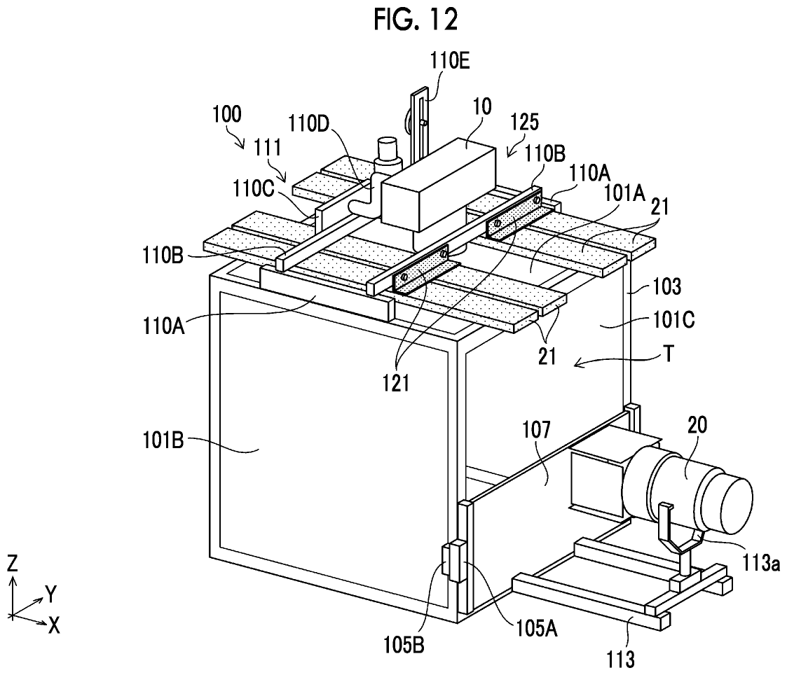

FIG. 12 is a diagram illustrating the imaging housing 100 included in the examination device 1 according to the present embodiment. FIG. 12 is a perspective view illustrating the imaging housing 100. Parts already described using FIG. 2 will be denoted by the same reference numerals and the description thereof will be omitted.

The second light sources 21 are provided on an upper surface of the housing 111 (surface formed by the panel 101A). In the illustrated case, four second light sources 21 are provided. The second light source 21 is attached by a second light source attachment part (light source attachment part) 121. Specifically, an upper end part of the second light source attachment part 121 is connected to a second attachment member 110B, and a lower end part thereof is attached to the second light sources 21.

In a case where the second light source 21 is provided, a transparent or translucent diffusion plate is used in the panel 101A.

Next, specific examples of light sources used in the first light source 20 and the second light source 21 will be described.

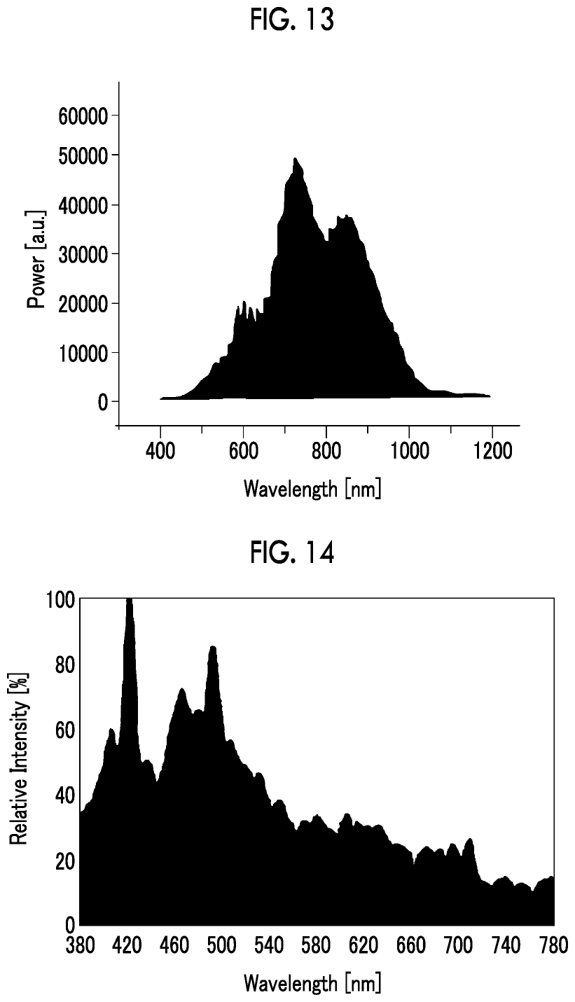

FIG. 13 is a diagram illustrating spectral data of a halogen lamp used as the first light source 20. The lateral axis indicates the wavelength, and the vertical axis indicates the intensity.

As illustrated in FIG. 13, the halogen lamp has an intensity on a long wavelength side. Therefore, according to the selection of the wavelength of the multispectral camera, the amount of the light of the first light source 20 is increased in a case where it is desired to have the intensity on a long wavelength side. Accordingly, the amount of the light corresponding to imaging data having a long wavelength acquired by the multispectral camera can be adjusted.

FIG. 14 is a diagram illustrating spectral data of the metal halide lamp used as the second light source 21. The lateral axis indicates the wavelength, and the vertical axis indicates the intensity.

As illustrated in FIG. 14, the metal halide lamp has an intensity on the short wavelength side. Therefore, according to the selection of the wavelength of the multispectral camera, the amount of the light of the second light source 21 is increased in a case where it is desired to have the intensity on a short wavelength side. Accordingly, the light amount corresponding to the imaging data of the short wavelength acquired by the multispectral camera can be adjusted.

As described above, according to the examination device 1 of the present embodiment, the imaging housing 100 comprises the first light source 20 and the second light source 21, and the control unit 3 changes the amounts of the light of the first light source 20 and the second light source 21 by the first intensity changing mechanism 5 and the second intensity changing mechanism 7, respectively. Accordingly, in the examination device 1, it is possible to perform the examination with the appropriate amount of light according to the environment in which the examination is performed and it is not necessary to adjust the amount of the light using the ND filter or the like.

In the above embodiment, a hardware structure of a processing unit (control unit 3) that executes various types of processing is the following various processors. The various processors include a central processing unit (CPU) which is a general-purpose processor functioning as various processing units by executing software (program), a programmable logic device (PLD) which is a processor capable of changing a circuit configuration after manufacturing such as a field programmable gate array (FPGA), a dedicated electric circuit, which is a processor having a circuit configuration exclusively designed to execute specific processing, such as an application specific integrated circuit (ASIC), and the like.

One processing unit may be composed of one of these various processors, or may be composed of two or more processors (for example, a plurality of FPGAs or a combination of the CPU and the FPGA) of the same type or different types. In addition, the plurality of processing units may be composed of one processor. As an example of the plurality of processing units that are composed of one processor, first, as represented by a computer such as a client or a server, a form in which one processor is composed of a combination of one or more CPUs and software and the processor functions as the plurality of processing units is possible. Second, as represented by a system on chip (SoC) or the like, a form of using a processor that implements functions of the entire system including the plurality of processing units in one integrated circuit (IC) chip is possible. Accordingly, the various processing units are configured using one or more of the various processors as a hardware structure.

Further, the hardware structure of these various processors is more specifically an electric circuit (circuitry) in which circuit elements such as semiconductor elements are combined.

Each of the above-described configurations and functions can be appropriately implemented by any hardware, software, or a combination of both. For example, the present invention can be applied to a program for causing a computer to execute the above-described processing steps (processing procedure), a computer-readable recording medium (non-transitory recording medium) in which such a program is recorded, or a computer on which such a program can be installed.

Although examples of the present invention have been described above, the present invention is not limited to the above-described embodiments, and various modifications can be made without departing from the scope of the present invention.

### EXPLANATION OF REFERENCES

1: examination device
3: control unit
5: first intensity changing mechanism
7: second intensity changing mechanism
10: imaging device
10a: lens barrel
20: first light source
21: second light source
100: imaging housing
101A: panel
101B: panel
101C: panel
101D: panel
101E: panel
103: panel frame
107: movable plate
110A: first attachment member
110B: second attachment member
110C: attachment plate
110D: tripod head
110E: height adjustment mechanism
111: housing
113: first light source attachment part
113a: changing mechanism
117: imaging device hood
121: second light source attachment part
125: imaging device attachment part
129A: ND filter
129B: frame
129C: band-pass filter
129D: polarization filter
130: optical member
200: lens device
202: lens barrel
208: slit
210: first lens
220: second lens
L: optical axis
S: workpiece
T: irradiation opening
U: lens opening

What is claimed is:

1. An imaging housing comprising:
a housing that covers an imaging space;
an imaging device attachment part that is provided on a first surface of the housing and to which an imaging device is attached; and
a light source attachment part that is provided on a second surface intersecting the first surface of the housing and to which a first light source that irradiates an inside of the housing is attached,
wherein the housing is provided with a diffusion member therein, and has a first opening facing a lens of the imaging device on the first surface, a second opening on the second surface, and a movable plate that changes an opening region of the second opening into which light of the first light source is incident, and
the light source attachment part has a changing mechanism capable of changing a direction of the first light source in the opening region.

2. The imaging housing according to claim 1,
wherein the diffusion member is exchangeable.

3. The imaging housing according to claim 1,
wherein the housing includes an insertion/removal mechanism, and the diffusion member is provided in the housing by the insertion/removal mechanism.

4. The imaging housing according to claim 1,
wherein the diffusion member attached to a bottom part of the housing is removable.

5. The imaging housing according to claim 1,
wherein an imaging device hood is provided on the first surface of the housing.

6. The imaging housing according to claim 1,
wherein the imaging device is attachably and detachably attached to the imaging device attachment part.

7. The imaging housing according to claim 1,
wherein the imaging device attachment part has an imaging direction adjustment mechanism that adjusts an imaging direction of the imaging device.

8. An examination device comprising:
the imaging housing according to claim 1;
an imaging device that is provided in the imaging device attachment part; and
a first light source that is provided in the light source attachment part.

9. The examination device according to claim 8,
wherein the light source attachment part includes a first light source attachment part and a second light source attachment part,
the first light source attachment part is provided with the first light source, and
the second light source attachment part is provided with a second light source.

10. The examination device according to claim 9, further comprising:
an intensity changing mechanism that changes wavelength intensities of the first light source and the second light source.

11. The examination device according to claim 8,
wherein the first light source is a halogen lamp, and the second light source is a metal halide lamp.

12. The examination device according to claim 8,
wherein the imaging device is a multispectral camera, and
the multispectral camera is a pupil division type in which a plurality of band-pass filters are disposed at a pupil position or in the vicinity of the pupil position.
